(19) United States
(12) Patent Application Publication
(10) Pub. No.: US 2023/0084584 A1
(43) Pub. Date: Mar. 16, 2023

(54) Chemical Solution Dilution And Delivery Device

(71) Applicant: Carl Hill, Riverside, CA (US)

(72) Inventor: Carl Hill, Riverside, CA (US)

(21) Appl. No.: 17/474,966

(22) Filed: Sep. 14, 2021

(51) Int. Cl. A01G 25/16; A01C 23/04; B01F 3/08

(52) U.S. Cl. CPC A01G 25/16; A01C 23/042; B01F 3/08; B01F 2003/0896

(57) ABSTRACT

A chemical solution dilution and delivery device for treating landscaping and gardens includes a vessel, which can contain a chemical solution, such as a fertilizer solution, an herbicide solution, and the like. A valve is engaged to the vessel proximate to a lower end of the vessel so that the valve is in fluidic communication with the vessel. A pipe is engaged to and extends bidirectionally from the valve. The pipe is in fluidic communication with the valve. The pipe has a first end and a second end, which are selectively engageable a pressurized water source and a spray assembly, respectively. The valve regulates a flowrate of the chemical solution from the vessel into water flowing through the pipe. A diluted chemical solution is dispensed from the spray assembly.

### (c) STATEMENT REGARDING FEDERALLY SPONSORED RESEARCH OR DEVELOPMENT

Not Applicable

### (b) CROSS-REFERENCE TO RELATED APPLICATIONS

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to chemical solution delivery devices and more particularly pertains to a new chemical solution delivery device for treating landscaping and gardens. The present invention discloses a chemical solution delivery device comprising a standalone vessel that is removably engage a pressurized water source via a pipe, which also connects to a spray assembly. The vessel has a handle for lifting and carrying the standalone vessel and a fill hole that is closable by a plug. A selector regulates a flow control valve to control a flowrate of the chemical solution into water flowing through the pipe.

### (2) Description of Related Art Including Information Disclosed Under 37 CFR 1.97 and 1.98

The prior art relates to chemical solution delivery devices. Prior art chemical solution delivery devices for landscaping and garden use are generally permanently attached to sprinkler systems. What is lacking in the prior art is a chemical solution delivery device comprising a standalone vessel and configured to removably engage a pressurized water source, such as a spigot, via a pipe, which also connects to a spray assembly, such as a sprinkler. The vessel has a handle for lifting and carrying the standalone vessel and a fill hole that is closable by a plug. A selector regulates a flow control valve to control a flowrate of the chemical solution into water flowing through the pipe.

### (H) BRIEF SUMMARY OF THE INVENTION

An embodiment of the disclosure meets the needs presented above by generally comprising a vessel, which is configured for positioning of a chemical solution, such as a fertilizer solution, an herbicide solution, and the like. A valve is engaged to the vessel proximate to a lower end of the vessel so that the valve is in fluidic communication with the vessel. A pipe is engaged to and extends bidirectionally from the valve. The pipe is in fluidic communication with the valve. The pipe has a first end and a second end, which are configured to selectively engage a pressurized water source and a spray assembly, respectively. The valve is configured to regulate a flowrate of the chemical solution from the vessel into water flowing through the pipe. A diluted chemical solution is dispensed from the spray assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a chemical solution dilution and delivery device according to an embodiment of the disclosure.

FIG. 2 is a rear view of an embodiment of the disclosure.

FIG. 3 is a side view of an embodiment of the disclosure.

FIG. 4 is a top view of an embodiment of the disclosure.

FIG. 5 is a bottom view of an embodiment of the disclosure.

FIG. 6 is an in-use view of an embodiment of the disclosure.

### (j) DETAILED DESCRIPTION OF THE INVENTION

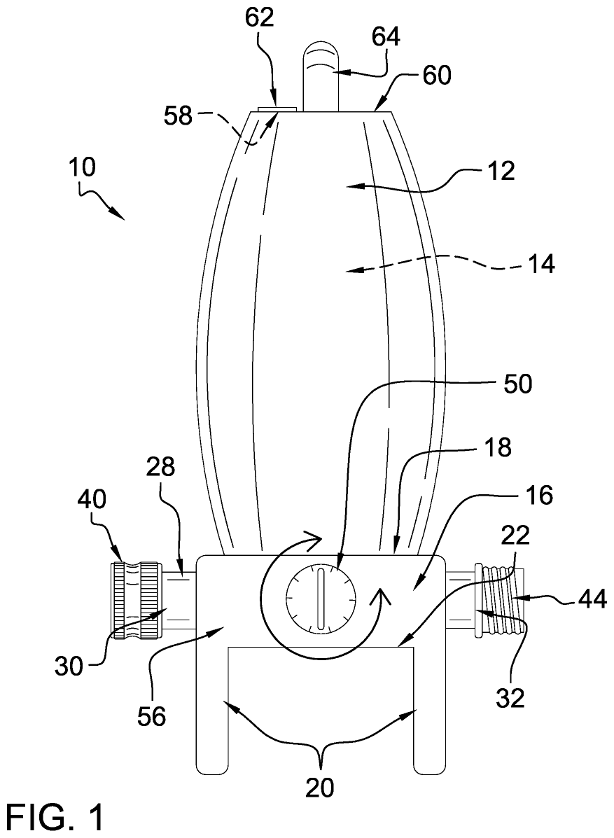

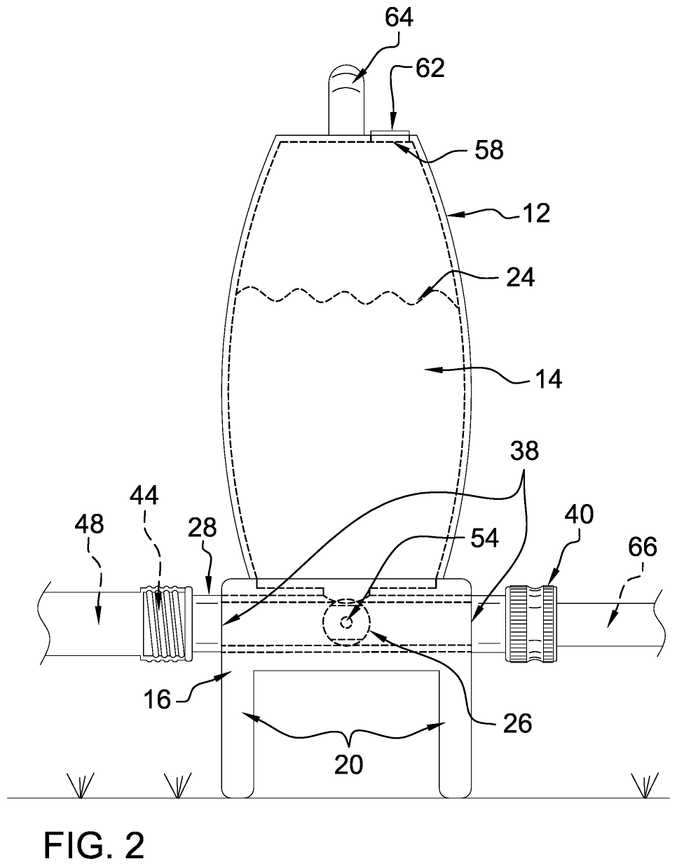

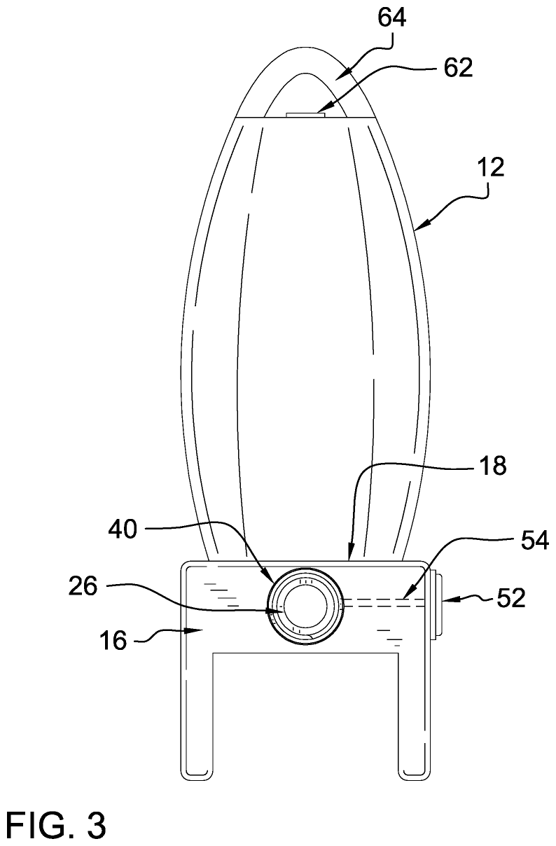

With reference now to the drawings, and in particular to FIGS. 1 through 6 thereof, a new chemical solution delivery device embodying the principles and concepts of an embodiment of the disclosure and generally designated by the reference numeral 10 will be described.

As best illustrated in FIGS. 1 through 6, the chemical solution dilution and delivery device 10 generally comprises a vessel 12, which is configured for positioning of a chemical solution 14, such as a fertilizer solution, an herbicide solution, and the like. A base 16 is engaged to a lower end 18 of the vessel 12 and is configured to support the vessel 12 in a substantially upright configuration on a surface. A plurality of legs 20 is engaged to and extends from a bottom 22 of the base 16 so that the base 16 is elevated from the surface. The vessel 12 may be substantially translucent so that a level 24 of the chemical solution 14 is visually assessable.

A valve 26 is engaged to the vessel 12 proximate to the lower end 18 of the vessel 12 so that the valve 26 is in fluidic communication with the vessel 12. A pipe 28 is engaged to and extends bidirectionally from the valve 26. The pipe 28 is in fluidic communication with the valve 26. The pipe 28 has a first end 30 and a second end 32, which are configured to selectively engage a pressurized water source 34 and a spray assembly 36, respectively.

The pipe 28 extends from opposed sides 38 of the base 16. A female hose connector 40 is engaged to the first end 30 of the pipe 28 and is configured to engage a first hose 42, which extends from the pressurized water source 38. A male hose connector 44 is engaged to the second end 32 of the pipe 28 and is configured to engage a second hose 46, which extends from the spray assembly 36, so that the spray assembly 36 is fluidically engaged to the pressurized water source 38 and the vessel 12.

The valve 26 is configured to regulate a flowrate of the chemical solution 14 from the vessel 12 into water 66 flowing through the pipe 28. A diluted chemical solution 48 is dispensed from the spray assembly 36. A selector 50 is engaged to the base 16 and is operationally engaged to the valve 26. The selector 50 is configured to be manipulated by a user to adjust the flowrate of the chemical solution 14 from the vessel 12 into the pipe 28. The selector 50 may comprise a dial 52, which is engaged to a stem 54 of the valve 26. The stem 54 extends through the base 16 so that the dial 52 is positioned on a front 56 of the base 16. The selector 50 may comprise other selection means, such as, but not limited to, hand wheels, buttons, and the like.

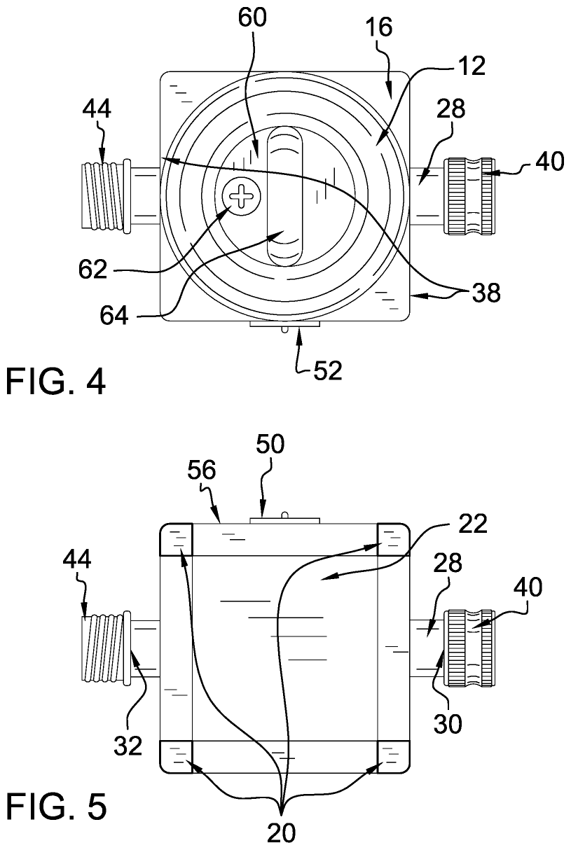

A hole 58 is positioned in the vessel 12 proximate to an upper end 60 of the vessel 12 and is configured for addition of the chemical solution 14 into the vessel 12. As shown in FIG. 4, the hole 58 is positioned in the upper end 60 of the vessel 12. A plug 62, which is complementary to the hole 58, is insertable into the hole 58 to close the hole 58. A handle 64 is engaged to the upper end 60 of the vessel 12 and is configured to be grasped in a hand of the user to lift the vessel 12 and the base 16.

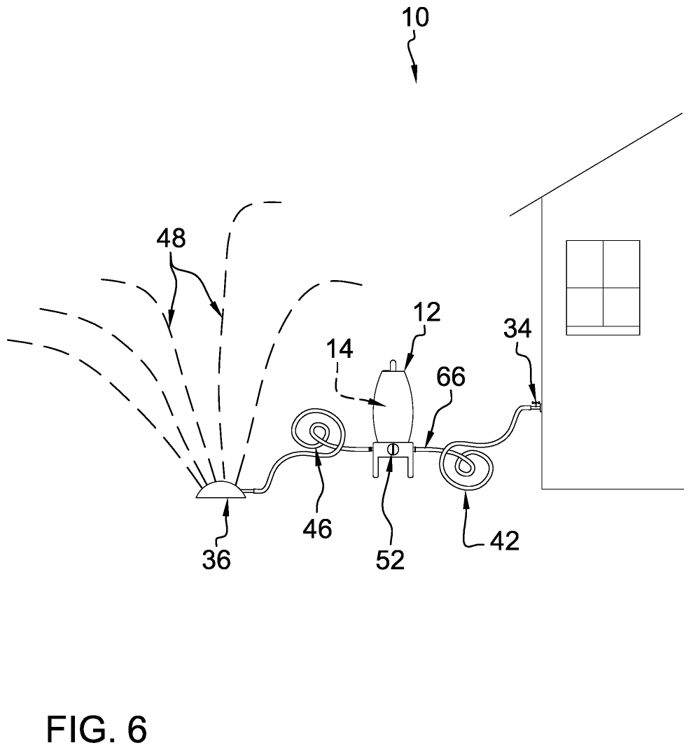

In use, a chemical solution 14 is positioned in the vessel 12 and the first hose 42 and the second hose 46 are engaged to the female hose connector 40 and the male hose connector 44, respectively. The first hose 42 and the second hose 46 then are connected to the pressurized water source 34 and the spray assembly 36, respectively, as shown in FIG. 6. The dial 52 is used to adjust the flowrate of the chemical solution 14 from the vessel 12 into the pipe 28. The chemical solution 14 is diluted by the water 66 flowing through the pipe 28 and the diluted chemical solution 48 is sprayed by the spray assembly 36 onto a target, such as a lawn, garden, trees, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chemical solution dilution and delivery device comprising:
a vessel configured for positioning a chemical solution;
a valve engaged to the vessel proximate to a lower end of the vessel, such that the valve is in fluidic communication with the vessel; and
a pipe engaged to and extending bidirectionally from the valve, such that the pipe is in fluidic communication with the valve, the pipe having a first end and a second end configured for selectively engaging a pressurized water source and a spray assembly, respectively, wherein the valve is configured for regulating a flowrate of the chemical solution from the vessel into water flowing through the pipe, such that a diluted chemical solution is dispensed from the spray assembly.

2. The chemical solution dilution and delivery device of claim 1, further including a base engaged to the lower end of the vessel and being configured for supporting the vessel in a substantially upright configuration on a surface, the pipe extending from opposed sides of the base.

3. The chemical solution dilution and delivery device of claim 2, further including a plurality of legs engaged to and extending from a bottom of the base, such that the base is elevated from the surface.

4. The chemical solution dilution and delivery device of claim 2, further including a selector engaged to the base and being operationally engaged to the valve, wherein the selector is configured for manipulation by a user for adjusting the flowrate of the chemical solution from the vessel into the pipe.

5. The chemical solution dilution and delivery device of claim 4, wherein the selector comprising a dial engaged to a stem of the valve, the stem extending through the base such that the dial is positioned on a front of the base.

6. The chemical solution dilution and delivery device of claim 1, further including:
a female hose connector engaged to the first end of the pipe, wherein the female hose connector is configured for engaging a first hose extending from the pressurized water source; and
a male hose connector engaged to the second end of the pipe, wherein the male hose connector is configured for engaging a second hose extending from the spray assembly, such that the spray assembly is fluidically engaged to the pressurized water source and the vessel.

7. The chemical solution dilution and delivery device of claim 1, further including:
a hole positioned in the vessel proximate to an upper end of the vessel, wherein the hole is configured for addition of the chemical solution into the vessel, the hole being positioned in the upper end of the vessel; and
a plug complementary to the hole, such that the plug is insertable into the hole for closing the hole.

8. The chemical solution dilution and delivery device of claim 1, further including a handle engaged to the upper end of the vessel, wherein the handle is configured for grasping in a hand of the user for lifting the vessel and the base.

9. A chemical solution dilution and delivery system comprising:
a pressurized water source;
a spray assembly;
a vessel;
a chemical solution positioned in the vessel;
a valve engaged to the vessel proximate to a lower end of the vessel, such that the valve is in fluidic communication with the vessel;
a pipe engaged to and extending bidirectionally from the valve, such that the pipe is in fluidic communication with the valve, the pipe having a first end and a second end;
a first hose engaged to and extending between the first end of the pipe and the pressurized water source; and
a second hose engaged to and extending between the second end of the pipe and the spray assembly, such that the spray assembly is fluidically engaged to the pressurized water source and the vessel, such that the valve is positioned for regulating a flowrate of the chemical solution from the vessel into water flowing through the pipe, such that a diluted chemical solution is dispensed from the spray assembly.

10. A chemical solution dilution and delivery device comprising:
a vessel configured for positioning a chemical solution;
a valve engaged to the vessel proximate to a lower end of the vessel, such that the valve is in fluidic communication with the vessel;
a pipe engaged to and extending bidirectionally from the valve, such that the pipe is in fluidic communication with the valve, the pipe having a first end and a second end configured for selectively engaging a pressurized water source and a spray assembly, respectively, wherein the valve is configured for regulating a flowrate of the chemical solution from the vessel into water flowing through the pipe, such that a diluted chemical solution is dispensed from the spray assembly;
a base engaged to the lower end of the vessel and being configured for supporting the vessel in a substantially upright configuration on a surface, the pipe extending from opposed sides of the base;
a selector engaged to the base and being operationally engaged to the valve, wherein the selector is configured for manipulation by a user for adjusting the flowrate of the chemical solution from the vessel into the pipe, the selector comprising a dial engaged to a stem of the valve, the stem extending through the base such that the dial is positioned on a front of the base;
a plurality of legs engaged to and extending from a bottom of the base, such that the base is elevated from the surface;
a female hose connector engaged to the first end of the pipe, wherein the female hose connector is configured for engaging a first hose extending from the pressurized water source;
a male hose connector engaged to the second end of the pipe, wherein the male hose connector is configured for engaging a second hose extending from the spray assembly, such that the spray assembly is fluidically engaged to the pressurized water source and the vessel;
a hole positioned in the vessel proximate to an upper end of the vessel, wherein the hole is configured for addition of the chemical solution into the vessel, the hole being positioned in the upper end of the vessel;
a plug complementary to the hole, such that the plug is insertable into the hole for closing the hole; and
a handle engaged to the upper end of the vessel, wherein the handle is configured for grasping in a hand of the user for lifting the vessel and the base.
